(19) United States
(12) Patent Application Publication
(10) Pub. No.: US 2014/0261311 A1
(43) Pub. Date: Sep. 18, 2014

(54) FUEL MIXER

(71) Applicant: GENERAC POWER SYSTEMS, INC., Waukesha, WI (US)

(72) Inventors: Don R. Bayer, Dousman, WI (US); Andrew D. Schill, Cudahy, WI (US); Peter D. Winnie, Jefferson, WI (US); Anthony J. Petcoff, West Allis, WI (US); Charles S. Raich, Ixonia, WI (US)

(73) Assignee: Generac Power Systems, Inc., Waukesha, WI (US)

(21) Appl. No.: 13/828,492

(22) Filed: Mar. 14, 2013

(51) Int. Cl. F02M 59/46

(52) U.S. Cl. CPC F02M 59/46
USPC 123/336

(57) ABSTRACT

A fuel mixer is provided that delivers a mixture of a gaseous fuel and air to an internal combustion engine by way of multi-stage operation by way of sequentially actuated primary and secondary throttle valves. The fuel mixer may include primary and secondary venturies that are defined within primary and secondary venturi tubes. The secondary venturi tube may be longitudinally aligned with an outlet of the fuel mixer. The primary venturi tube may be arranged at an angle with respect to the secondary venturi tube and the outlet of the fuel mixer.

### FIELD OF THE INVENTION

The present invention relates generally to internal combustion engines and, in particular, to fuel mixers that mix gaseous fuels with air for use in internal combustion engines.

### BACKGROUND OF THE INVENTION

Some internal combustion engines run on gaseous fuels, such as liquid propane and natural gas. These engines use a fuel mixer that creates a mixture of the gaseous fuel and air that is burned in the engine. Some of these engines are used in fixed speed applications in which the engine runs under load at a rated fixed speed that can optimize efficiency of the engine. This can be done by using single venture-type fuel mixers on fixed speed gaseous fuel burning engines that are tuned to deliver the mixture of gaseous fuel and air at an air-fuel ratio that approximates a stoichiometric ratio for the particular gaseous fuel while the engine is running at the rated fixed speed, allowing for efficient operation. However, some fuel mixers that are tuned for efficient rated fixed speed operation of gaseous fuel burning engines can over fuel during start up and at speeds below the rated fixed speed.

### SUMMARY OF THE INVENTION

The present invention is directed to a fuel mixer that allows for multi-stage operation that allows for operating a gaseous fuel burning engine to operate efficiently at a rated fixed speed and at speeds below the rated fixed speed. This may do done with a dual barrel mixer that has a relatively smaller primary venturi, a relatively larger secondary venturi, and primary and secondary throttle valves that are progressively linked to each other for staged actuation.

According to one aspect of the invention, a fuel mixer for an internal combustion engine that can burn a gaseous fuel is provided that includes a mixer body which has an intake end for receiving air to be mixed with a gaseous fuel and an outlet end for delivering the mixture of the gaseous fuel and air to the engine. A primary venturi extends from the intake end of the mixer body toward the outlet end of the mixer body and has a primary venturi diameter that is defined by a minimum diameter of an opening that extends through the primary venturi. A primary throttle valve is arranged with respect to the primary venturi and the outlet end of the mixer body so that the primary throttle can move for controlling flow of the mixture of gaseous fuel and air through the primary venturi. A secondary venturi extends from the intake end of the mixer body toward the outlet end of the mixer body and has a secondary venturi diameter that is defined by a minimum diameter of an opening that extends through the secondary venturi. A secondary throttle valve is arranged with respect to the secondary venturi and the outlet end of the mixer body so that the secondary throttle can move for controlling flow of the mixture of gaseous fuel and air through the secondary venturi. A throttle actuator system is connected to both of the primary and secondary throttle valves and is arranged to move the primary throttle valve before the secondary throttle valve. This may provide multi-stage operation that allows for a flow of a relatively lower volume of gaseous fuel and air at speeds below a rated fixed speed and a relatively greater volume of gaseous fuel and air at a rated fixed speed.

According to another aspect of the invention, the throttle actuator system may include a primary throttle shaft that supports the primary throttle valve for rotation about the primary throttle shaft for controlling flow of the mixture of gaseous fuel and air through the primary venturi and a secondary throttle shaft that supports the secondary throttle valve for rotation about the secondary throttle shaft for controlling flow of the mixture of gaseous fuel and air through the secondary venturi. A linkage bar may extend between and connect the primary and secondary throttle shafts to each other for translating movement of the primary throttle shaft into movement of the secondary throttle shaft. A primary throttle arm may extend from the primary throttle shaft and include a pin that engages the linkage bar for moving the linkage bar so as to rotate the secondary throttle shaft. A secondary throttle arm may extend from the secondary throttle shaft and be connected to a first end of the linkage bar that is opposite a second end of the linkage bar and may include a slot. The pin of the primary throttle arm may be arranged within the slot of the linkage bar so that the pin of the primary throttle arm can translate along a length of the slot during rotation of the primary throttle valve. This may provide a simple linkage arrangement that can provide progressive actuation of the primary and secondary throttle valves.

According to another aspect of the invention, the slot of the linkage bar may be curved. The curve of the slot of the linkage bar may define a radius of curvature that corresponds to a length of a radius that is circumscribed by an arcuate path that the pin of the primary throttle arm travels during rotation of the primary throttle valve. This may provide a linkage arrangement that can move easily with relatively low friction between components and that resists binding.

According to another aspect of the invention, an actuator may be arranged to rotate the primary throttle shaft. The actuator is an electric motor, for example, a stepper motor. This may allow for accurately controlled movement of the primary and secondary throttle valves with a single actuator. The single actuator may allow for controlling the throttle actuator system to provide a first stage of operation in which only the primary throttle valve moves for use during starting and operation below the fixed rated speed of the engine. A transition point may be defined at an end of the first stage, after which point the secondary throttle valve begins to move during a second stage of operation. During the second stage of operation, the primary and secondary throttle valves move together until both are fully open, at which time the engine operates at the fixed rated speed. In a similar way, another aspect of the invention may provide a method for delivering a gaseous fuel to an internal combustion engine by delivering a gaseous fuel into a primary venturi that defines a primary flow path through a fuel mixer, rotating a primary throttle shaft with an actuator through a first range of motion to move a primary throttle valve that is arranged in the primary flow path, and rotating the primary throttle shaft with the actuator through a second range of motion such that the primary throttle valve in the primary flow path and a secondary throttle valve that is arranged in a secondary venturi that defines a secondary flow path through the fuel mixer move simultaneously. This may provide multi-stage operation that allows for a flow of a relatively lower volume of gaseous fuel and air at speeds below a rated fixed speed and a relatively greater volume of gaseous fuel and air at a rated fixed speed.

According to another aspect of the invention, the outlet end of the mixer body includes an outlet and the secondary venturi may be longitudinally aligned with the outlet of the fuel mixer body. The primary venturi may be arranged at an angle with respect to the secondary venturi. This may allow the primary venturi to be positioned below the secondary venturi and between cylinder banks of a V-twin engine which provides a compact arrangement of the fuel mixer with respect to the engine.

According to another aspect of the invention, at least one of the primary and secondary venturies may be defined within a venturi tube that is seated within the mixer body. Both of the primary and secondary venturies may be defined within a primary venturi tube and a secondary venturi tube, respectively, within the mixer body. The mixer body may include sockets that accept and hold at least parts of the primary and secondary venturi tubes. At least one o-ring may be arranged between the venturi tube(s) and the mixer body and a pair of o-rings may be arranged between each venturi tube and the mixed body. A fastener may secure both of the primary and secondary venturi tubes in the mixer body. This may allow the mixer body to be used in different applications by replacing the primary and secondary venturi tubes with others that have different sized venturi diameters.

According to another aspect of the invention, the fuel mixer includes a fuel selector that is arranged for movement with respect to the mixer body for selecting one of multiple gaseous fuels to be burned in the engine. The fuel selector may include a fuel selector pin that has holes that are different sizes and that can selectively align with the primary and secondary venturies based on the selected gaseous fuel for delivery of the selected gaseous fuel through at least one hole of the fuel selector pin of a corresponding size. The fuel selector pin may include a groove that extends in a spiral direction with respect to a length of the fuel selector pin and that engages the mixer body so that rotating the fuel selector pin in first and second directions axially advances and regresses the fuel selector pin with respect to the mixer body for aligning the different sized holes with the primary and secondary venturies based on the selected gaseous fuel. This may allow for conversion of the fuel mixer for use of different gaseous fuels without taking apart the fuel mixer or an air box assembly and in a tool-less manner.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a simplified and partially schematic representation of an electrical generator incorporating a fuel mixer in accordance with the present invention;

FIG. 2 is a pictorial view of the fuel mixer of FIG. 1;

FIG. 3 is a cross-sectional view of the fuel mixer taken at line 3-3 in FIG. 2;

FIG. 4 is an exploded pictorial view of the fuel mixer of FIG. 1;

FIG. 5 is an exploded pictorial view of a variant of the fuel selector of FIG. 4;

FIG. 6 is a close-up side elevation view of the throttle actuator system of FIG. 4;

FIG. 7 is a cross-sectional view of the fuel mixer of FIG. 1 in a first stage of operation;

FIG. 8 is a cross-sectional view of the fuel mixer of FIG. 1 at a transition point of operation; and

FIG. 9 is a cross-sectional view of the fuel mixer of FIG. 1 in a second stage of operation.

### DETAILED DESCRIPTION OF THE DRAWINGS

Referring now to the drawings and specifically to FIG. 1, a fuel mixer 5 is shown that is used to deliver a mixture of a fuel such as a gaseous fuel and air to be burned by an internal combustion engine 7. The engine 7 is shown as driving a generator set 9 in an electrical generator 11, although it is understood that the engine 7 may be used in other applications.

Still referring to FIG. 1, a gaseous fuel such as propane or natural gas is introduced into the electrical generator 11 through a tube 13 that is connected to a demand regulator 15. Demand regulator 15 directs metered amounts of the fuel to the fuel mixer 5 based on consumption demand of the engine 7, such as a vacuum signal, as is known. Demand regulator 15 can be one that is provided for use with the OHVI engine in a GUARDIAN Series electrical generator available from the GENERAC POWER SYSTEMS company of Waukesha, Wis. Fuel lines 17 direct the gaseous fuel from the demand regulator 15 for delivery into the fuel mixer 5, as described in greater detail elsewhere herein. The fuel mixer 5 receives the fuel from the fuel lines 17 and mixes the fuel with air that is delivered into the fuel mixer 5 through an airbox 19.

Still referring to FIG. 1, fuel mixer 5 includes a body 21 that has in inlet end 23 with a flange 25 for connecting the fuel mixer 5 to the airbox 19 and an outlet end 27 that has a flange 29 for connecting the fuel mixer 5 to an intake manifold 31. The intake manifold 31 directs the mixture of fuel and air from the fuel mixer 5 to the engine 7 to be burned in the cylinders 33 of the engine 7.

Referring now to FIG. 2, the body 21 defines a dual barrel arrangement with two barrels, shown as primary barrel 35 and secondary barrel 37. Fuel inlets 39 receive ends of the fuel lines 17 and are fluidly connected to the primary and secondary barrels 35, 37 for delivering metered amounts of fuel from the demand regulator 15 (FIG. 1) into the primary and secondary barrels 35, 37, respectively, through openings 40 that may have different sizes based on a desired rate of fuel to be delivered into the primary and secondary barrels 35, 37. Primary barrel 35 is adapted to deliver relatively less fuel and air in a mixture to the engine 7 for relatively lower speed operation. Secondary barrel 37 is adapted to deliver relatively more fuel and air to the engine 7 for relatively higher speed operation.

Still referring to FIG. 2, primary barrel 35 includes a primary venturi 41 that has a longitudinally extending opening 43 that restricts to a minimum diameter that defines a primary venturi diameter 45. A primary throttle valve 47 that has a circular perimeter shape is arranged downstream of the restriction of the opening 43 and is movable to control an amount of the mixture of fuel and air that can flow through the primary barrel 35 into the engine 7.

Still referring to FIG. 2, secondary barrel 37 includes a secondary venturi 49 that has a longitudinally extending opening 51 that restricts to a minimum diameter that defines a secondary venturi diameter 53. A secondary throttle valve 55 that has a circular perimeter shape is arranged downstream of the restriction of the opening 51 and is movable to control an amount of the mixture of fuel and air that can flow through the secondary barrel 37 into the engine 7. As shown in FIG. 3, the secondary venturi and throttle valves 49, 55 are larger than the primary venturi and throttle valves 41, 47. This allows relatively more air and fuel to flow through the secondary barrel 37 and relatively less air and fuel to flow through the primary barrel 35.

Referring now to FIG. 4, the primary and secondary venturies 41, 49 are defined within primary and secondary venturi tubes 57, 59 that are arranged within sockets 61, 63 of the mixer body 21. A cylindrical primary throat 65 of the mixer body 21 extends from the socket 61 and intersects at an angle with a cylindrical secondary throat 67 of the mixer body 21 that extends from the socket 63. The sockets 61, 63 have larger diameters than the primary and secondary throats 65, 67, respectively, and step changes in diameter or shoulders are defined between the respective sockets 61, 63 and primary and secondary throats 65, 67.

Still referring to FIG. 4, the primary and secondary venturi tubes 57, 59 have side walls 69, 71 that define outer ends 73, 75, intermediate segments 77, 79, and inner ends 81, 83. The side walls 69, 71 taper conically inwardly from the outer ends 73, 75 to the intermediate segments 77, 79, where the primary and secondary venturi diameters 45, 53 are defined. The side walls 69, 71 extend cylindrically from the intermediate segments 77, 79 to the inner ends 81, 83 of the primary and secondary venturi tubes 57, 59. A screw 84 secures both of the primary and secondary venturi tubes 57, 59 into the mixer body 21 by clamping tabs that extend from the outer ends 73, 75 against the mixer body 21. This allows a single mixer body 21 to be reconfigurable to removably accept different primary and secondary venturi tubes 57, 59 with venturies 41, 49 of different sizes or otherwise on different configurations, based on the particular air/fuel mixture requirements of a particular engine 7 (FIG. 1) with which the fuel mixer 5 is being used.

Still referring to FIG. 4, each of the primary and secondary venturi tubes 57, 59 includes a pair of flanges 85 that are longitudinally spaced from each other and extend radially from the intermediate segments 77, 79 and inner ends 81, 83. O-rings 87 are seated in channels 89 of the flanges 85 and provide sealing interfaces between the venturi tubes 57, 59 and the sockets 61, 63 of the mixer body 21. In this way, a fuel cavity 91 is defined within each of the sockets 61, 63 concentrically between respective side walls of the sockets 61, 63 and the primary and secondary venturi tubes 57, 59 and longitudinally between respective pairs of the flanges 85 in the same socket 61, 63. The fuel cavities 91 are fluidly connected to the openings 40 and fuel inlets 39 that deliver fuel into the primary and secondary barrels 35, 37. Slots 93, 95 extend through the side walls 69, 71 of the primary and secondary venturi tubes 57, 59, between the respective flanges 85. The slots 93, 95 allow fuel that is delivered through the fuel inlet 39 and opening 40 into the fuel cavities 91 to flow inwardly from the fuel cavities 91 into the openings 43, 51 of the primary and secondary venturies 41, 49. The slots 93, 95 are sized based on a desired delivery rate of fuel from the fuel cavities 91 into a flow path of air through each of the primary and secondary venturies 41, 49.

Referring still to FIG. 4, the particular type of fuel to be burned by engine 7 (FIG. 1) can be selected by way of a fuel selector 97 that is arranged for movement with respect to the mixer body 21 for making such a selection. Fuel selector 97 includes a fuel selector pin 99 that is arranged for movement concentrically within a fuel selector tube 100 that extends transversely between the fuel inlets 39 and the openings 40 of the primary and secondary barrels 35, 37. The fuel selector pin 99 has multiple adjacent primary holes 101 and multiple adjacent secondary holes 103 that can be selectively aligned between the fuel inlets 39 and the openings 40. The primary holes 101 are different sizes and the secondary holes 103 are different sizes. By selecting a pair of a primary hole 101 and a secondary hole 103, such as an inner-most or an outer-most pair of the primary and secondary holes 101, 103, relatively smaller or relatively larger openings can be fluidly connected between the fuel inlets 39 and the fuel cavities 91. This allows for relatively less or relatively more fuel to be mixed into the flows of air that are directed through the primary and secondary venturies 41, 49, based on the type of fuel being delivered to mix with air and to be burned by the engine 7 (FIG. 1), for example, natural gas or liquid propane. An inner end 105 of the fuel selector pin 99 includes a groove 107 that extends in a spiral direction with respect to a length of the fuel selector pin 99. The groove 107 engages the mixer body 21, for example, a pin (not shown) that is fixed with respect to the mixer body 21 and extends into the fuel selector tube 100. In this way, the fuel selector pin 99 is arranged within the fuel selector tube 100 so that rotating the fuel selector pin 99 in a first direction advances further into the mixer body 21 to an inward position in which the outer-most primary and secondary holes 101, 103 align with the fuel inlets 39. Rotating the selector pin 99 in a second, opposite direction axially withdraws the fuel selector pin 99 to an outward position in which the inner-most primary and secondary holes 101, 103 align with the fuel inlets 39. A pin 109 attaches a knob 111 to an outer end 113 of the fuel selector pin 99 for allowing a user to grip for turning the fuel selector pin 99 in or out to select a type of fuel to be burned by the engine 7 (FIG. 1).

Referring now to FIG. 5, the fuel selector 97 is mostly identical to that of FIG. 4, whereby such descriptions are applicable here with respect to the fuel selector 97 of FIG. 5. The fuel selector 97 of FIG. 5 differs from that of FIG. 4 in the following ways. The fuel selector 97 of FIG. 5 includes a fuel selector pin 99 with an intermediate portion 110 that is relatively narrower than the inner and outer ends 105, 113. A pair of plates 112 that define curved profiles are arranged on opposing sides of the intermediate portion 110. The plates 112 connect to each other or to the intermediate portion by way of posts 110A that provide a snap fit engagement for holding the plates 112 to the fuel selector pin 99. The plates 112, in combination, concentrically surround the intermediate portion 110. Each plate 112 includes primary openings 101A and secondary openings 103A that aligned with the primary and secondary holes 101, 103 of the intermediate portion 110, respectively. An inner seal 101B is arranged at an outwardly facing surface 112A of the plate 112, extending about a perimeter of the respective primary opening 101A. An outer seal 101C is arranged at the outwardly facing surface 112Aa of the plate 112, extending about the pair of inner seals 101B. An inner seal 103B is arranged at the outwardly facing surface 112A of the plate 112, extending about a perimeter of the respective secondary opening 103A. An outer seal 103C is arranged at the outwardly facing surface 112Aa of the plate 112, extending about the pair of inner seals 103B.

Referring again to FIG. 4, fuel that is delivered through the fuel inlets 39, fuel selector pin 99, openings 40, and is drawn from the fuel cavity 91 through the slots 93, 95 and air that flows through the venturies 41, 49, is metered by the primary and secondary throttle valves 47, 55. A throttle actuator system 114 includes a primary throttle shaft 115 that supports the primary throttle valve 47. The primary throttle shaft 115 can rotate within and extends transversely through the primary throat 65. A first end 117 of the primary throttle shaft is connected by way of a cylindrical coupler 119 to an output shaft 121 of an actuator 123, shown as an electric motor which can be a stepper motor. The actuator 123 is operably connected to a control system 125 that includes a controller 127 and a power supply 129, as is known, for controlling the actuator 123. The controller 127 can include an industrial computer or, e.g., a programmable logic controller (PLC), along with corresponding software and suitable memory for storing such software and hardware, including interconnecting conductors for power and signal transmission for controlling the actuator 123 and may also control other electronic or electro-mechanical components of the engine 7 and/or electrical generator 11. In this way, the actuator 123 can rotate its output shaft 121 which correspondingly rotates the primary throttle shaft 115 and the primary throttle valve 47 to control the volume of the mixture of air and fuel that can flow through primary barrel 35. This is done by way of a variable restriction through the primary throat 65 depending on the angular orientation and thus surface area of the throttle valve 47 that is presented against a primary flow path along which the mixture of fuel and air flows through the primary barrel 35.

Still referring to FIG. 4, a secondary throttle shaft 131 supports the secondary throttle valve 55. The secondary throttle shaft 131 can rotate within and extends transversely through the secondary throat 67. A pair of bearings 133 supports opposing ends of the secondary throttle shaft 131. Rotation of the secondary throttle shaft and throttle valve 131, 55 controls the volume of the mixture of air and fuel that can flow through secondary barrel 37. This is done by way of a variable restriction through the secondary throat 67 depending on the angular orientation and thus surface area of the secondary throttle valve 55 that is presented against a secondary flow path along which the mixture of fuel and air flows through the secondary barrel 37. A return spring 135 biases the secondary throttle shaft and valve 131, 55 into a closed position. The secondary throttle valve 55 is arranged in the secondary throat 67 at a location that is upstream of a position of intersection of the primary throat 65 with the secondary throat 67. In this way, a mixture of fuel and air can be directed through the primary barrel 35 while a flow through the secondary venturi 49 is completely restricted by the secondary throttle valve 55 in a closed position in a manner that allows for staged performance of the fuel mixer 5. Referring now to FIGS. 4 and 6, the throttle actuator system 114 includes a linkage assembly 137 that connects the primary and secondary throttle shafts 115, 131 to each other for staged progressive movement. The linkage assembly 137 includes a primary throttle arm 139 that is arranged on and moves in unison with a second end 141 (FIG. 4) of the primary throttle shaft 115. The primary throttle arm 139 extends in a radial direction from the primary throttle shaft 115 and includes a pin 143 that extends parallel to and away from the primary throttle shaft 115. An idle control mechanism 144 includes a screw 144A and a spring 144B that cooperate with each other and are arranged to engage the primary throttle arm 139 for adjusting idle speed by adjusting a minimum angled position of the primary throttle valve 47 and thus the minimum size of an opening past the throttle valve 47 when the throttle valve 47 is in a closed position for idling of the engine 7 (FIG. 1). Referring now to FIG. 6, the screw 144A extends adjustably through threads in a post 144C that extends outwardly from the body 21 of the fuel mixer 5 so that an end of the screw 144A engages the primary throttle arm 139 to adjustably set a stop position preventing further travel of the primary throttle arm 139.

Referring again to FIGS. 4 and 6, a secondary throttle arm 145 is arranged on and moves in unison with an end 147 (FIG. 4) of the secondary throttle shaft 131. The secondary throttle arm 145 extends in a radial direction from the secondary throttle shaft 131 and includes a pin 149. Referring again to FIG. 6, the secondary throttle arm 145 includes a first end 145A that tapers downwardly away from the secondary throttle shaft 131 and a second end 145B defining a finger 145C extending opposite the first end 145A. A pin 149 extends from the first end 145A of the throttle arm 145, parallel to and away from the secondary throttle shaft 131. Referring again to FIGS. 4 and 6, a maximum speed control mechanism 146 includes a screw 146A and a spring 146B that cooperate with each other and are arranged to engage the secondary throttle arm 145 for adjusting maximum engine speed by adjusting a maximum angled position of the secondary throttle valve 55 (FIG. 4) and thus the maximum size of an opening past the throttle valve 55 when the throttle valve 55 is in a wide-open position for maximum speed operation of the engine 7 (FIG. 1). Referring again to FIG. 6, the screw 146A extends adjustably through threads in a post 146C that extends outwardly from the body 21 of the fuel mixer 5 so that an end of the screw 146A engages finger 145C of the secondary throttle arm 145 to adjustably set a stop position preventing further travel of the secondary throttle arm 145.

Referring still to FIG. 6, a linkage bar 151 extends between and connects the primary and secondary throttle arms 139, 145 to each other. A hole 153 extends through an upper end 155 of the linkage bar 151. The pin 149 of the secondary throttle arm 145 extends through and is captured for rotation inside of the hole 153 of the linkage bar 151. A slot 157 extends from a lower end 159 of the linkage bar 151 toward an intermediate segment 161 of the linkage bar 151. The pin 143 of the primary throttle arm 139 extends through and is slidingly held within the slot 157 of the linkage bar 151. This allows the primary throttle arm 139 to move relative to the linkage bar 151 while the linkage bar 151 sits still until the pin 143 of the primary throttle arm 139 travels through the entire length of the slot 157 and abuts an end wall 159A at a first end of the slot 157 that is opposite an end wall 159B at an opposing end of the slot 157. This defines a transition point (FIG. 8) after which further movement of the primary throttle arm 139 forces movement of the linkage bar 151 by way of the pin 143 pushing the linkage bar 151 at the end wall 159A of its slot 157. As shown in FIGS. 8-9, the slot 157 of the linkage bar 151 is curved. The curve of the slot 157 of the linkage bar 151 defines a radius of curvature that corresponds to a length of a radius that is circumscribed by an arcuate path that the pin 143 of the primary throttle arm 139 travels during rotation of the primary throttle shaft 115 (FIG. 7).

Referring now to FIG. 7, a first stage of operation of the fuel mixer 5 is defined by movement of the primary throttle shaft 115 before the transition point, which is shown in FIG. 6 and in the dashed-phantom line representation of the pin 143 in FIG. 7. Referring to FIGS. 6 and 7, a second stage of operation is defined by continued movement of the primary throttle shaft 115 after the transition point (FIG. 8), until a wide open throttle position is achieved as shown in FIG. 9. The wide open throttle position (FIG. 9) may be for operating the engine 7 at a rated fixed speed and which may be maintained in a known way by a governor (not shown) of the engine 7 (FIG. 1).

In light of the above, the fuel mixer 5 provides multi-stage use in the following way. Referring to FIG. 7, during starting and low speed operation, which may include low speed exercise of the electrical generator 11, the first stage of operation is employed. The actuator 123 (FIG. 4) rotates the primary throttle shaft and valve 115, 47 within a range of movement that does not pass through the transition point (FIG. 8). A mixture of air and fuel can only flow through the primary barrel 35 during this first stage, whereby a relatively small amount of air and fuel can be burned by the engine 7 (FIG. 1) so as to provide slow speed and low fuel and low emissions operation. When increased power output and/or speed is required, the actuator 123 (FIG. 4) rotates the primary throttle shaft and valve 115, 47 through the transition point (FIG. 7), which moves the primary and secondary throttle valves 47, 55 at the same time during the second operational stage in opposite directions while opening until the wide open throttle position is obtained (FIG. 9). The engine speed can be slowed down by performing the multi-stage operation sequence of the fuel mixer 5 described above in the opposite order.

Many changes and modifications could be made to the invention without departing from the spirit thereof. The scope of these changes will become apparent from the appended claims.

1. A fuel mixer for an internal combustion engine, comprising:
a mixer body that includes an intake end for receiving air to be mixed with a gaseous fuel in the mixer body so as to create a mixture of gaseous fuel and air to be burned in an internal combustion engine and an outlet end for delivering the mixture of the gaseous fuel and air to the engine;
a primary venturi that extends from the intake end of the mixer body toward the outlet end of the mixer body and that has a primary venturi diameter that is defined by a minimum diameter of an opening that extends through the primary venturi;
a primary throttle valve that is arranged with respect to the primary venturi and the outlet end of the mixer body so that the primary throttle can move for controlling flow of the mixture of gaseous fuel and air through the primary venturi;
a secondary venturi that extends from the intake end of the mixer body toward the outlet end of the mixer body and that has a secondary venturi diameter that is defined by a minimum diameter of an opening that extends through the secondary venturi;
a secondary throttle valve that is arranged with respect to the secondary venturi and the outlet end of the mixer body so that the secondary throttle can move for controlling flow of the mixture of gaseous fuel and air through the secondary venturi; and
a throttle actuator system that is connected to both of the primary and secondary throttle valves and is arranged to move the primary throttle valve before the secondary throttle valve.

2. The fuel mixer of claim 1, wherein the throttle actuator system includes a primary throttle shaft that supports the primary throttle valve for rotation about the primary throttle shaft for controlling flow of the mixture of gaseous fuel and air through the primary venturi and a secondary throttle shaft that supports the secondary throttle valve for rotation about the secondary throttle shaft for controlling flow of the mixture of gaseous fuel and air through the secondary venturi, and a linkage bar that extends between and connects the primary and secondary throttle shafts to each other for translating movement of the primary throttle shaft into movement of the secondary throttle shaft.

3. The fuel mixer of claim 2, wherein a primary throttle arm extends from the primary throttle shaft and includes a pin that engages the linkage bar for moving the linkage bar so as to rotate the secondary throttle shaft.

4. The fuel mixer of claim 3, wherein a secondary throttle arm extends from the secondary throttle shaft and is connected to a first end of the linkage bar that is opposite a second end of the linkage bar that includes a slot and wherein the pin of the primary throttle arm is arranged within the slot of the linkage bar so that the pin of the primary throttle arm can translate along a length of the slot during rotation of the primary throttle valve.

5. The fuel mixer of claim 4, wherein the slot of the linkage bar is curved.

6. The fuel mixer of claim 5, wherein the curve of the slot of the linkage bar defines a radius of curvature that corresponds to a length of a radius that is circumscribed by an arcuate path that the pin of the primary throttle arm travels during rotation of the primary throttle valve.

7. The fuel mixer of claim 1, wherein the outlet end of the mixer body includes an outlet and wherein the secondary venturi is longitudinally aligned with the outlet of the fuel mixer body.

8. The fuel mixer of claim 1, wherein the primary venturi is arranged at an angle with respect to the secondary venturi.

9. The fuel mixer of claim 8, wherein the outlet end of the mixer body includes an outlet, and wherein the secondary venturi is longitudinally aligned with the outlet of the fuel mixer body so that the primary venturi is arranged at an angle with respect to each of the secondary venturi and the outlet of the fuel mixer body.

10. The fuel mixer of claim 1, wherein the at least one of the primary and secondary venturies is defined within a venturi tube that is seated within the mixer body.

11. The fuel mixer of claim 10, wherein an o-ring is arranged between the venturi tube and the mixer body.

12. The fuel mixer of claim 11, wherein a pair of o-rings that are spaced from each other along the length of the venturi tube are arranged between the venturi tube and the mixer body.

13. The fuel mixer of claim 1, further comprising a fuel selector that is arranged for movement with respect to the mixer body for selecting one of multiple gaseous fuels to be burned in the engine.

14. The fuel mixer of claim 13, wherein the fuel selector includes a fuel selector pin that has holes that are different sizes and that can selectively align with the primary and secondary venturies based on the selected gaseous fuel for delivery of the selected gaseous fuel through at least one hole of the fuel selector pin of a corresponding size.

15. The fuel mixer of claim 14, wherein the fuel selector pin includes a groove that extends in a spiral direction with respect to a length of the fuel selector pin and that engages the mixer body so that rotating the fuel selector pin in first and second directions axially advances and regresses the fuel selector pin with respect to the mixer body for aligning the different sized holes with the primary and secondary venturies based on the selected gaseous fuel.

16. A fuel mixer for delivering a mixture of gaseous fuel to an internal combustion engine, the fuel mixer comprising:
a mixer body;
a primary venturi that is arranged in the mixer body and that has a primary venturi diameter that is defined by a minimum diameter of an opening that extends through the primary venturi;
a primary throttle valve that is mounted to a primary throttle shaft that can rotate so as to rotate the primary throttle valve within the primary venturi for controlling flow of the mixture of gaseous fuel and air through the primary venturi;
a secondary venturi that is arranged in the mixer body and that has a secondary venturi diameter that is defined by a minimum diameter of an opening that extends through the secondary venturi;
a secondary throttle valve that is mounted to a secondary throttle shaft that can rotate so as to rotate the secondary throttle valve within the secondary venturi for controlling flow of the mixture of gaseous fuel and air through the secondary venturi;
an actuator that is arranged to rotate the primary throttle shaft; and
a linkage arm that is arranged between the primary and secondary throttle shafts so that the first throttle shaft rotates independently of the second throttle shaft during a first range of motion of the first throttle shaft and the linkage arm can translate rotation of the first throttle shaft to the second throttle shaft during a second range of motion of the first throttle shaft.

17. The fuel mixer of claim 16, wherein the actuator is an electric motor.

18. The fuel mixer of claim 17, wherein the electric motor is a stepper motor.

19. A method for delivering a gaseous fuel to an internal combustion engine, the method comprising:
delivering a gaseous fuel into a primary venturi that defines a primary flow path through a fuel mixer;
rotating a primary throttle shaft with an actuator through a first range of motion to move a primary throttle valve that is arranged in the primary flow path; and
rotating the primary throttle shaft with the actuator through a second range of motion such that the primary throttle valve in the primary flow path and a secondary throttle valve that is arranged in a secondary venturi that defines a secondary flow path through the fuel mixer move simultaneously.

20. The method of claim 19, wherein the primary and secondary flow paths angularly intersect each other.
